(19) United States
(12) Patent Application Publication
(10) Pub. No.: US 2007/0259118 A1
(43) Pub. Date: Nov. 8, 2007

(54) Method of treating a plastic article

(75) Inventors: Robert A. Pyles, Bethel Park, PA (US); Rick L. Archey, Pleasant Hills, PA (US)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 11/417,380

(22) Filed: May 4, 2006

(51) Int. Cl. B05D 3/12; B05D 3/10; B05D 1/30; B05D 1/02

(52) U.S. Cl. 427/337; 427/240; 427/421.1; 427/420

(57) ABSTRACT

A method of impregnating a plastic article with a drug is disclosed. Accordingly at least a portion of the surface of a plastic article is contacted with a treatment composition which contains: (i) at least one drug; (ii) water; (iii) at least one carrier represented by the following general Formula I, 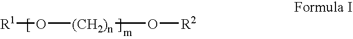
wherein R¹ is a radical selected from the group consisting of linear or branched C₁-C₁₈ alkyl, benzyl, benzoyl and phenyl, R² is R¹ or H, n is 2, 3 or 4, and m is 1 to 35; and (iv) a diol.

### FIELD OF THE INVENTION

The present invention relates to a method of treating a plastic article, more specifically a method for modifying the properties of a molded article.

### BACKGROUND OF THE INVENTION

Treated plastic articles (e.g., containing performance enhancing additives) can be prepared by means of incorporating (e.g., by means of compounding) additives directly into the polymeric materials from which the articles are prepared. Such direct (or bulk) incorporation methods result in the additive being dispersed substantially throughout the bulk of the plastic article.

Performance enhancing additives, such as UV stabilizers (absorbers), and modifying additives such.as drugs are typically expensive, and as such minimizing the amount incorporated into the plastic article while at the same time maintaining a sufficient level of performance is desirable. Direct incorporation methods are not particularly well suited with regard to minimizing the amount of performance enhancing additive used, as it is distributed throughout the whole of the plastic article. With direct incorporation methods, reducing the amount of performance enhancing additive throughout the bulk of the plastic article results in an equivalent reduction at the surface thereof, where it is typically most needed due to interactions of the surface with the environment (e.g., with light, oxygen, the interior surfaces of a mold and/or in the case of drugs, body fluids). As a result, physical properties of the plastic article or efficacy of drugs are typically sacrificed if the amount of performance enhancing or modifying additive is too far reduced in a direct incorporation method. Additionally, many performance enhancing and modifying additives are sensitive to elevated temperatures. Hence, the higher temperatures required to melt-mix additives with polymeric materials can cause the additives to decompose and lose their performance enhancing and modifying properties. In contrast, a low temperature means of introducing these temperature-sensitive additives into polymeric materials, can result in the selection of additives useful in the various polymeric materials becoming significantly larger.

The preparation of treated plastic articles by applying a treatment composition to the surface of the plastic article is generally known. Because the additives are incorporated primarily into the surface of the plastic article, such surface treatment methods are better suited with regard to minimizing the amount of performance enhancing or modifying additive used while at the same time maintaining a sufficient level of performance.

Typically, the treatment compositions that are applied to the surface of the plastic article are non-aqueous. In light of environmental concerns related to the use of organic solvents, more recently there has been increased emphasis towards the development of treatment methods that make use of aqueous treatment compositions. Methods of treating plastic articles by means of aqueous treatment compositions typically suffer from disadvantages that include, for example, non-uniform and/or inadequate treatment of the article, and an inconsistent degree of treatment and resulting physical properties between different batches of the same plastic articles.

U.S. Pat. No. 4,535,104 discloses a thermoplastic aromatic copolyestercarbonate article that is surface impregnated with a specific class of UV light degradation inhibiting compound. The '104 patent discloses dipping the thermoplastic copolyestercarbonate article into a non-aqueous solution of butoxy ethanol and UV stabilizer heated to a temperature of 125° C., followed by drying of the article at 150° C.

U.S. Pat. No. 4,323,597 discloses a method of preparing ultraviolet radiation stabilized polymeric article (e.g., of polycarbonate) by applying to the surface thereof a composition containing ultraviolet radiation absorber and a non-aggressive liquid carrier. The '597 patent discloses examples of non-aggressive liquid carriers as including hydroxy ethers, alcohols, alcohol-water mixtures, liquid hydrocarbons and chlorofluorocarbons.

It would be desirable to develop new methods of treating plastic articles that make use of aqueous treatment compositions, and that result in the formation of uniformly and sufficiently treated articles. In addition, it would be desirable that such new methods also provide consistent degrees of treatment over time.

### SUMMARY OF THE INVENTION

In accordance with the present invention, there is provided a method of treating a plastic article comprising:
(a) providing a plastic article comprising at least one polymer selected from thermoplastic polymer and thermoset polymer;
(b) contacting at least a portion of the surface of said plastic article with a treatment composition comprising,
   (i) at least one drug,
   (ii) water,
   (iii) at least one carrier represented by the following general Formula I, 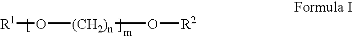
      wherein R¹ is a radical selected from the group consisting of linear or branched C₁-C₁₈ alkyl, benzyl, benzoyl and phenyl, R² is R¹ or H,
      n is 2, 3 or 4, and
      m is 1 to 35, and
   (iv) a diol selected from at least one of linear and branched C₂-C₂₀ aliphatic diols, cycloaliphatic diols having from 5 to 8 carbon atoms in the cyclic ring, and aromatic diols.
(c) maintaining said portion of said plastic article in contact with said treatment composition for a period of time at least sufficient to form a treated plastic article; and
(d) removing said treated plastic article from contact with said treatment composition.

### DETAILED DESCRIPTION OF THE INVENTION

The treatment composition (or bath) used in the method of the present invention includes at least one carrier conforming to Formula I. Linear or branched alkyls from which R¹ and R² of Formula I may each be independently selected include, but are not limited to, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl and octadecyl, and structural isomers thereof (e.g., iso-propyl, i-butyl, t-butyl, etc.).

With further reference to Formula I, R¹ and R² may each also be independently selected from benzyl, benzoyl and phenyl groups, each of which may independently and optionally be substituted with 1 to 5 groups selected from halo groups (e.g., chloro, bromo and fluoro), linear or branched C₁-C₉ alkyl groups (e.g., methyl, ethyl, propyl, butyl, pentyl, hexyl, heptyl, octyl and nonyl), and aromatic groups (e.g., phenyl).

In an embodiment of the present invention, regarding Formula I, n is 2, R¹ is selected from n-butyl, i-butyl and t-butyl, and R² is hydrogen. In a particularly preferred embodiment of the present invention, n is 2, m is 1, R¹ is n-butyl, and R² is H.

The carrier is typically present in the treatment composition in a positive amount up to 30 percent by weight, preferably 10 to 25 percent by weight, and more preferably 17 to 20 percent by weight. The carrier may be present in the treatment composition in an amount ranging between any combination of these upper and lower values, inclusive of the values thereof. The percent weights being based on the total weight of the treatment composition, in each case.

The treatment composition also includes a diol that may be linear or branched C₂-C₂₀ aliphatic diol, for instance poly(C₂-C₄ alkylene glycol), cycloaliphatic diols having from 5 to 8 carbon atoms in the cyclic ring, as well as aromatic diols, such as bisphenols. Examples of linear or branched C₂-C₂₀ aliphatic diols include ethylene glycol, propylene glycol, 1,3-propane diol, 1,2- and 2,3-butane diol, pentane diols, hexane diols, heptane diols, octane diols, nonane diols, decane diols, undecane diols, dodecane diols, tridecane diols, tetradecane diols, pentadecane diols, hexadecane diols, heptadecane diols, octadecane diols, nonadecane diols and icosane diols.

Examples of poly(C₂-C₄)alkylene glycols include di-, tri-, tetra-, penta- and higher ethylene glycols, di-, tri-, tetra-, penta- and higher propylene glycols, and di-, tri-, tetra-, penta- and higher butylene glycols. Cycloaliphatic diols having from 5 to 8 carbon atoms include cyclopentane diol, cyclohexane diol, cyclohexane dimethanol, cycloheptane diol and cyclooctane diol. Examples of aromatic diols include benzene diol, e.g., 1,2-dihydroxy benzene and 1,3-dihydroxy benzene; C₁-C₄ alkyl substituted benzene diol, e.g., 4-tert-butyl-benzene-1,2-diol, 4-methyl-benzene-1,2-diol, 3-tert-butyl-5-methyl-benzene-1,2-diol and 3,4,5,6-tetramethyl-benzene-1,2-diol; halo substituted benzene diol, e.g., 3,5-dichlorobenzene-1,2-diol, 3,4,5,6-tetrabromo-benzene-1,2-diol and 3,4,5-trichloro-benzene-1,2-diol; and C₁-C₄ alkyl and halo substituted benzene diol, e.g., 3-bromo-5-tert-butyl-benzene-1,2-diol, 3,6-dichloro-4-methyl-benzene-1,2-diol, 3,-bromo-4,5-dimethyl-benzene-1,2-diol and 3-chloro-4,6-di-tert-butyl-benzene-1,2-diol.

Bisphenols and hydrogenated bisphenols that may be used as diols and include those conforming to Formula II, 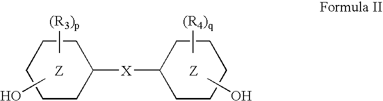
wherein R₃ and R₄ are each selected independently from each other and independently for each p and q from C₁-C₄ alkyl (e.g., methyl, ethyl, n-propyl, iso-propyl, n-butyl, sec-butyl and tert-butyl), chlorine and bromine;
p and q are each independently an integer from 0 to 4; and —X— is a divalent linking group selected from —O—, —S—, —S(O₂)—, —C(O)—, —CH₂—, —CH═CH—, —C(CH₃)₂—, and
—C(CH₃)(C₆H₅)—; and 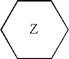
represents a benzene ring or a cyclohexane ring. An example of a bisphenol that may be used as diol (iv) is 4,4′-isopropylidenebisphenol (i.e., bisphenol A). An example of a hydrogenated bisphenol is 4,4′-isopropylidenebiscyclohexanol.

In a preferred embodiment the diol is at least one member selected from the group consisting of diethylene glycol, triethylene glycol, tetraethylene glycol, and pentaethylene glycol and mixtures thereof. Particularly preferred diols are diethylene glycol and propylene glycol.

The diol is typically present in the treatment composition in a positive amount up to 20 percent by weight, preferably 5 to 15 percent by weight, and more preferably 7 to 12 percent by weight. The percent weights being based on the total weight of the treatment composition, in each case.

Water is typically present in the treatment composition in a positive amount up to 90 percent by weight, preferably 50 to 85 percent by weight The percent weights being based on the total weight of the treatment composition. The water used is preferably deionized and/or distilled water.

The treatment composition includes at least one drug as a performance enhancing additive. The drugs that may be used in the context of the invention include any one or a combination of: analgesics, antacids, antianxiety drugs, antiarrhythmics, antibacterial, antibiotics, anticoagulants and thrombolytics, anticonvulsants, antidepressants, antidiarrheals, antiemetics, antifungals, antihistamines, antihypertensives, anti-inflammatories, antineoplastics, antipsychotics, antipyretics, antivirals, barbiturates, beta-blockers, bronchodilators, cold cures, corticosteroids, cough suppressants, cytotoxics, decongestants, diuretics, expectorant, hormones, hypoglycemics (oral) immunosuppressives, laxatives, muscle relaxants, sedatives, sex hormones (female), sex hormones (male), sleeping drugs, tranquilizers, vitamins and blood thinners.

The treatment composition may further contain additional performance additives such as UV stabilizers, optical brighteners, mold release agents, antistatic agents, thermal stabilizers, IR absorbers, drugs and antimicrobial agents. Suitable such additives are known and available in commerce.

The amount of performance additive present in the treatment composition may vary widely. Typically the performance additive is present in the treatment composition in an amount sufficient to result in the formation of a “treated plastic article”. The term “treated plastic article” in the present context refers to an article made by the inventive process and possessing the desired drug-related efficacy such as the capacity to release diffused drugs.

The amount of performance additive that is actually present in the treatment composition will depend on the solubility of the drug within the mixture of water, carrier and diol. The solubility of the drug within the treatment composition will also be affected by the temperature of the composition. In those instances where the drug is not fully soluble in the composition, the treatment composition is deemed to contain a saturated level of drug. By adding an amount of drug that is in excess of the saturation level in the composition (e.g., by placing drug in a bag filter through which the treatment composition is continually passed) the level of drug in the treatment composition may be maintained at the saturation level during treatment operations. The level (e.g., the saturation level) of the drug in the composition may be determined periodically or continuously by, for example, thermogravimetric analysis or spectrophotometric analysis.

The drug is typically present in the treatment composition in a positive amount totaling less than or equal to 15 percent by weight, more typically less than or equal to 10 percent by weight, preferably less than or equal to 5 percent by weight, and more preferably less than or equal to 0.05 percent by weight. The drug is typically present in the treatment composition in an amount totaling at least 0.001 percent by weight, preferably at least 0.005 percent by weight, and more preferably at least 0.01 percent by weight. The drug may be present in the treatment composition in a total amount ranging between any combination of these upper and lower values, inclusive of the recited values thereof. For example, the drug may be present in the treatment composition in an amount typically totaling from 0.001 to 15 percent by weight, more typically from 0.005 to 5 percent by weight, and further typically in an amount of from 0.01 to 1 percent by weight. The percent weights being based on the total weight of the treatment composition, in each case.

In an embodiment of the present invention, the treatment composition may optionally further include a surfactant (or emulsifier), which is different from each of the carrier and the diol. Suitable surfactants in the present invention are readily dispersible upon being poured into water, and then form an emulsion upon agitation thereof.

Alternatively the drug may be premixed or coated with the surfactant prior to introducing the thus treated drug into the solution as a means to increase solubility. However, care must be taken to insure that the efficacy of the drug is not substantially affected by this treatment.

Examples of anionic surfactants that may be used in the present invention include, for example, amine salts or alkali salts of carboxylic, sulfamic or phosphoric acids, for example sodium lauryl sulfate, ammonium lauryl sulfate, lignosulfonic acid salts, ethylene diamine tetra acetic acid (EDTA) sodium salts and acid salts of amines such as laurylamine hydrochloride or poly(oxy-1,2-ethanediyl),alpha.-sulfo-omega-hydroxy ether with phenol 1-(methylphenyl)ethyl derivative ammonium salts

Amphoteric surfactants that may be present include, for example: lauryl sulfobetaine; dihydroxy ethylalkyl betaine; amido betaine based on coconut acids; disodium N-lauryl amino propionate; or the sodium salts of dicarboxylic acid coconut derivatives.

Examples of poly(C₂-C₄ alkoxylated) C₁₄-C₁₈ unsaturated fatty acids include, ethoxylated, propoxylated and/or butoxylated tetradecenyl carboxylic acid.

The optional surfactant (emulsifier) may be used in an amount less than or equal to 5 percent by weight. Preferably the optional surfactant is present in the treatment composition in an amount of 0.001 to 5 percent by weight, and more preferably in an amount of 3 to 4 percent by weight. The percent weights, in each case, being based on the weight of the treatment composition.

The method of the present invention involves treating a plastic article. The plastic article may comprise at least one polymer selected from thermoplastic and/or thermoset polymers. In an embodiment of the present invention, the plastic article comprises a polymer selected from at least one of (co)polyesters, (co)polycarbonates, polyesterpolycarbonate copolymers, acrylonitrile-butadiene-styrene (ABS) copolymers, polyamides, polyurethanes, polyalkyl(meth)acrylate (e.g., polymethylmethacrylate), polyvinylalcohols, polybutadiene rubber, rubber nitrites (acrylonitrile/butadiene copolymer), EPDM, polysiloxanes including silicone rubbers, and styrene copolymers (e.g., styrene acrylonitrile copolymers). The (co)polyesters, (co)polycarbonates, polyesterpolycarbonate copolymers may be aliphatic or aromatic polymers (e.g., containing residues of bisphenol A). These recited polymers may be thermoplastic polymers, thermoset polymers or a combination thereof, as the case may be.

The plastic article may contain known additives including such as dyes; mold release agents; fillers; reinforcing agents in the form of fibers or flakes; flame retardant agents; pigments; and opacifying agents, and light-diffusing agents.

The plastic article may be a molded plastic article, which is prepared by art-recognized methods including compression molding, injection molding, rotational molding, extrusion, injection and extrusion blow molding, and casting. The molded plastic article may be selected from shaped articles, films (e.g., having a thickness of less than 30 mils, and sheets (e.g., having a thickness of greater than or equal to 30 mils).

In the method of the present invention the plastic article is contacted with the treatment composition by: (I) dipping or immersing at least a portion of the surface of the plastic article into the treatment composition; and/or (II) applying the treatment composition to at least a portion of the surface of the plastic article.

When dipping or immersing is employed as the means by which the treatment composition is contacted with the plastic article, the plastic article to be treated is immersed at least partially in the treatment composition for a period of time and at temperature at least sufficient to facilitate at least some impregnation (diffusion or imbibition), of the drug into the surface of the plastic article, thus effecting treatment thereof. The time and temperature employed typically depends on the composition of the plastic article and the nature of the drug. Thermoset plastic articles are typically more resistant to heat (e.g., having a higher heat distortion temperature) than thermoplastic articles. As such, thermoset plastic articles can typically withstand immersion in treatment baths at higher temperatures than thermoplastic articles, providing the drug survives the elevated temperatures.

Immersion times are typically less than or equal to 8 hours, more typically less than or equal to 4 hours, and even more typically less than or equal to 1 hour. Immersion times are also typically at least 1 second, more typically at least 15 seconds, and even more typically at least 1 minute. The immersion time may range between any of these upper and lower values, inclusive of the recited values. In an embodiment of the present invention, the immersion time is typically from 5 seconds to 8 hours, more typically from 15 seconds to 4 hours, and further typically from 1 minute to 1 hour (e.g., 1 to 5 minutes).

Aside from dipping, or in addition thereto, the treatment composition may be applied to at least a portion of the surface of the plastic article by methods that include, but are not limited to, spray application, curtain application and/or spin application. Spray application methods typically involve placing the plastic article in a spray chamber that includes a plurality of spray nozzles. The treatment composition is passed through the spray nozzles and contacts at least a portion of the surface of the plastic article. Excess treatment composition is typically collected from the base of the spray chamber, filtered and recycled back to the spray nozzles. The treated plastic article is removed from the chamber, and excess treatment composition may be removed therefrom by further spraying with deionized or distilled water, followed by drying.

Curtain application methods are particularly well suited for, though not limited to, the treatment of substantially flat plastic articles, e.g., plastic articles in the form of films or sheets. The plastic article is typically passed through (or under) at least one continually falling curtain of the treatment composition. After passing through the falling curtain of treatment composition, the plastic article is typically rinsed with deionized water and dried.

Spin application methods are suited for, though not limited to, the treatment of substantially flat plastic articles, e.g., plastic articles in the form of flat discs. A measured amount of treatment composition is typically applied to the center of the plastic article, such as a plastic disc, and the plastic article is spun causing the treatment composition to spread over the surface thereof. The treatment composition may be allowed to remain in contact with the surface of the plastic article for a period of time (e.g., 60 seconds), followed by rinsing with deionized or distilled water and drying.

The temperature of the treatment composition when contacted with the plastic article (e.g., during dipping or application, such as spray application, methods) is typically at least room temperature (e.g., 25° C.) and less than the boiling and/or decomposition temperature of the treatment composition. Typically the treatment composition is maintained at a temperature of 25° C. to 99° C., for example from 60° C. to 97° C. or from 70° C. to 95° C. As described previously herein, the time and temperature of contact with the plastic article will depend at least in part on the type of plastic article that is to be treated. For example, with plastic articles of thermoplastic aromatic polycarbonate, treatment may be efficiently carried out at a temperature of 90 to 99° C., with a contact time of typically less than 1 hour, and more typically in the range of 1 to 15 minutes. In some instances the drug may be more quickly and efficiently imbibed into a softer plastic article, such as a softer thermoplastic article, in which case a lower treatment composition temperature will typically suffice. For example, plastic articles fabricated from thermoplastic polyurethanes, or thermoplastic styrene-acrylonitrile copolymers (SAN's), may be readily treated using the same treatment composition used for treating thermoplastic aromatic polycarbonate, but at temperatures of 70° C. and 80° C. respectively.

The treatment composition may be prepared by mixing the drug, water, carrier, diol and optional surfactants together in any order. For example the carrier and diol may be mixed together with the drug, and then this mixture is either added to water or water is added to it. In an embodiment, the treatment composition is formed by: (i) preparing a mixture of water, carrier and diol; (ii) introducing the drug into a filter; and (iii) passing the mixture over the drug and through the filter, thereby forming the treatment composition. The treatment composition, or at least a portion thereof, is then typically passed continuously through the filter. Optionally, the mixture of water, carrier and diol may be heated, e.g., heated to a temperature of 25° C. to 99° C., or 60° C. to 97° C., or 70° C. to 95° C., and then the heated mixture is contacted with the drug in the filter.

The filter into which the performance additive(s) is added, may be any suitable filter known to the skilled artisan. A preferred type of filter is a bag filter. Preparing and maintaining the treatment composition in this manner, ensures that the level of drug in the composition is maintained substantially at a saturation level (as discussed previously herein). In addition, passing the treatment composition continuously through the bag filter serves to remove particulate contaminants therefrom which could foul the treated plastic articles prepared by immersion in the treatment composition.

Upon removal from contact with the treatment composition, the treated plastic article is typically rinsed to remove excess drug therefrom. Rinsing typically uses water, and optionally a carrier (iii) represented by Formula I, and/or a diol (iv). The water of the rinse composition may be deionized or distilled water. After rinsing, the treated plastic article is typically dried.

### EXAMPLES

A treatment composition is prepared as follows:

1897.6 grams of deionized water, 492.9 grams of ethyleneglycol monolbutylether (as a carrier), and 308.1 grams of diethyleneglycol (as diol) are mixed together in a mixing tank to form a liquid mixture. The liquid mixture is heated to 95° C., and then forwarded continuously through a 20 micron bag filter into which 5.0 grams of a drug is placed. The drug is a member selected from the group consisting of analgesics, antacids, antianxiety medicaments, antarrhthmics, anticoagulants, thrombolytics, anticonvulsants, antidepressants, antidarrheals, antiemetics, antifungals, antihistamines, antihypertensives, antiinflamatories, antineoplastics, antipsychotics, antipyretics, antivirals, barbiturates, beta-blockers, bronchodilators, cold cures, corticosteroids, cough suppressants, cytotoxics, decongestants, diuretics, expectorant, hormones, hypoglycemics (oral) immunosuppressives, laxatives, muscle relaxants, sedatives, sex hormones (female), sex hormones (male), sleeping drugs, tranquilizers, vitamins and blood thinners.

The heated mixture containing the drug is cycled from the mixing tank through the bag filter and back to the mixing tank for a period of time sufficient to saturate the mixture of water, carrier and diol with the drug, to form the treatment bath. The treatment bath is continuously cycled through the system at a temperature of 95° C., and at a rate of 72 liters/minute. Typically, a small amount of drug is present within the bag filter.

Articles formed of thermoplastic polycarbonate are immersed in the treatment composition for a period of 3 minutes. The thermoplastic polycarbonate is a homopolycarbonate based on bisphenol A, having a MFR value of 6 to 12 g/10 minutes (per ASTM D 1238). Upon removal from the treatment composition, the treated article is rinsed first with drug-free water, butylcellosolve and diethylene glycol solution and then deioinized water and dried.

Articles formed of thermoplastic polyurethane are treated in a similar manner with the exception that the treatment composition temperature is maintained at 70° C., and the polyurethane articles are rinsed only with deionized water. The thermoplastic polyurethane is a Bayer Texin 940 polymer based on the combination of diisocyanate (MDI), polytetramethylene oxide and butanediol. The molecular weight is 150,000.

The present invention has been described with reference to specific details of particular embodiments thereof. It is not intended that such details be regarded as limitations upon the scope of the invention except insofar as and to the extent that they are included in the accompanying claims.

What is claimed is:

1. A method of treating a plastic article comprising:
(a) providing a plastic article comprising at least one polymer selected from thermoplastic polymer and thermoset polymer;
(b) contacting at least a portion of the surface of said plastic article with a treatment composition comprising,
(i) at least one drug,
(ii) water,
(iii) at least one carrier conforming to Formula I, 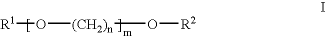
wherein R¹ is a radical selected from the group consisting of linear or branched C₁-C₁₈ alkyl, benzyl, benzoyl and phenyl, R² is R¹ or H, n is 2, 3 or 4, and m is 1 to 35, and
(iv) at least one diol selected from the group consisting of linear and branched C₂-C₂₀ aliphatic diols, cycloaliphatic diols having from 5 to 8 carbon atoms in the cyclic ring, and aromatic diols;
(c) maintaining said portion of said plastic article in contact with said treatment composition for a period of time at least sufficient to form a treated plastic article; and
(d) removing said treated plastic article from contact with said treatment composition.

2. The method of claim 1 wherein said treatment composition is maintained at a temperature of 25 to 99° C.

3. The method of claim 1 wherein said contacting is by dipping.

4. The method of claim 1 wherein said contacting is by at least one of spray application, curtain application and spin application.

5. The method of claim 1 wherein said thermoplastic polymer is a member selected from the group consisting of (co)polyesters, (co)polycarbonates, polyesterpolycarbonate copolymers, acrylonitrile-butadiene-styrene copolymers, polyamides, polyurethanes, polyalkyl(meth)acrylate, polyvinylalcohols, polybutadiene rubber, rubber nitriles, EPDM, polysiloxanes, and (co)polystyrene.

6. The method of claim 1 wherein R¹ is C₁-C₁₈ alkyl, R² is C₁-C₁₈ alkyl or H, and n is 2.

7. The method of claim 6 wherein R¹ is n-butyl, i-butyl or t-butyl, and R² n-butyl, i-butyl, t-butyl or H.

8. The method of claim 1 wherein said diol is at least one member selected from the group consisting of diethylene glycol, triethylene glycol, tetraethylene glycol and pentaethylene glycol.

9. The method of claim 8 wherein said diol is diethylene glycol.

10. The method of claim 8 wherein R¹ is C₁-C₁₈ alkyl, R² is H, n is 2 and m is 1.

11. The method of claim 10 wherein R¹ is n-butyl, i-butyl or t-butyl.

12. The method of claim 1 wherein said plastic article comprises at least one of static dyes, photochromic dyes, pigments, microspheres and metal flakes.

13. The method of claim 1 wherein said plastic article is molded.

14. The method of claim 1 wherein said plastic article is a film.

15. The method of claim 1 wherein said plastic article is a sheet.

16. The method of claim 1 wherein said treatment composition further include a surfactant.
